(19) United States
(12) Patent Application Publication
(10) Pub. No.: US 2025/0075792 A1
(43) Pub. Date: Mar. 6, 2025

(54) DEVICE AND METHOD FOR CONTROLLING AN ELECTROHYDRAULIC TRANSMISSION

(71) Applicant: POCLAIN HYDRAULICS INDUSTRIE, Verberie (FR)

(72) Inventor: Loris TAXIL, Verberie (FR)

(73) Assignee: POCLAIN HYDRAULICS INDUSTRIE, Verberie (FR)

(21) Appl. No.: 18/722,055

(22) PCT Filed: Dec. 22, 2022
(86) PCT No.: PCT/FR2022/052472

§ 371 Date: Jun. 20, 2024

(30) Foreign Application Priority Data
Dec. 22, 2021 (FR) FR2114252

(51) Int. Cl. F16H 61/435; B60K 17/356; B60K 25/00; B60L 1/00; B60L 15/20; F16H 39/02; F16H 59/44; F16H 59/78

(52) U.S. Cl. CPC F16H 61/435; B60K 25/00; B60L 1/003; B60L 15/2054; F16H 39/02; F16H 59/44; F16H 59/78; B60K 17/356; B60K 2025/005

(57) ABSTRACT

A propulsion system for vehicle propulsion component having a variable displacement hydraulic pump, a hydraulic motor, adapted to drive the rotation of the propulsion component, an electric motor, adapted to drive the hydraulic pump, a source of electric power, and a controller configured, as a function of a setpoint value, to control the displacement of the hydraulic pump and the rotational speed of the electric motor so as to achieve the setpoint value while maintaining a rotational speed of the electric motor greater than a lower threshold value.

### TECHNICAL FIELD

This presentation relates to a device and a control process for an electric transmission, especially for an electric vehicle, and in particular for a temporary assistance device.

### PRIOR ART

Different solutions are known which propose integrating an electrohydraulic propulsion device for vehicles or engines having a primary thermal motor or a primary electric motor.

Different transmission architectures have been proposed for implementing propulsion of a vehicle, especially a vehicle combining hydraulic drive elements with thermal or electrical elements, and in particular for the case of temporary assistance by means of hydraulic assistance, for example electrohydraulic.

However, the different architectures proposed raise problems in terms of optimisation and execution, due to the absence of a process or specific control system and also due to the specificities of the different elements which have distinct optimal operational ranges.

The present invention aims to respond to these problems at least partially.

### Presentation of the Invention

The present invention therefore relates to a propulsion system for vehicle propulsion component,

characterised in that it comprises
a variable displacement hydraulic pump,
a hydraulic motor, adapted to drive the rotation of said propulsion component, the hydraulic motor being driven by the hydraulic pump via a closed-loop hydraulic circuit,
an electric motor, adapted to drive the hydraulic pump,
a source of electric power, adapted to feed the electric motor,
   a controller configured, as a function of a setpoint value, to control the displacement of the hydraulic pump and the rotational speed of the electric motor so as to achieve the setpoint value while maintaining a rotational speed of the electric motor greater than a lower threshold value, the rotational speed of the electric motor being controlled between the lower threshold value Vmin and a maximal rotational speed Vmax, and the displacement of the hydraulic pump being controlled in a range of displacement values between a lower threshold value C1 and a maximum displacement value Cmax.

In particular, electric propulsion engines operate poorly at reduced speed, deliver reduced torque only and can heat up. On the other hand, hydraulic circuits may be damaged for very low rotational speeds, in particular if they incorporate booster pumps, and their output is also degraded. These problems are unwelcome for starting up from zero speed, and for operations at very low speed relative to the available range of speed of the transmission.

According to an example, the setpoint value is a setpoint value of torque delivered by the electric motor and/or a flow setpoint value delivered by the hydraulic pump.

According to an example, the controller is configured so as to control the displacement of the hydraulic pump and the rotational speed of the electric motor so as to achieve the setpoint value by maximising the output of the hydraulic pump while maintaining a rotational speed of the electric motor greater than the lower threshold value.

According to an example, the controller is configured to control the displacement of the hydraulic pump and the rotational speed of the electric motor so as to achieve the setpoint value and to maximise the torque delivered by the electric motor while maintaining a rotational speed of the electric motor greater than the lower threshold value and a displacement of the hydraulic pump greater than a lower threshold value.

According to an example, the system also comprises a temperature sensor, and the lower threshold value is determined by the controller as a function of the temperature value measured by the temperature sensor.

According to an example, the hydraulic motor is a fixed displacement hydraulic motor.

The system can also comprise means for determining the rotational speed of the propulsion component, for example a rotational speed sensor of the propulsion component, the controller being configured so as to:
if the rotational speed of the propulsion component is between 0 and a first threshold, control the displacement of the hydraulic pump to achieve the setpoint value while maintaining a rotational speed of the electric motor equal to the lower threshold value.

According to an example, the controller is configured so as to,
if the rotational speed of the propulsion component is greater than the first threshold and less than a second threshold, control the rotational speed of the electric motor to achieve the setpoint value while keeping the displacement of the hydraulic pump equal to a first displacement value.

According to an example, the controller is configured so as to,
if the rotational speed of the propulsion component is greater than the first threshold and less than a second threshold, control the rotational speed of the electric motor to achieve the setpoint value while keeping the displacement of the hydraulic pump equal to a first displacement value,
if the rotational speed of the propulsion component is greater than the second threshold, control the displacement of the hydraulic pump and the rotational speed of the electric motor to achieve the setpoint value by maximising the rotational speed of the electric motor.

According to an example, the system also comprises an auxiliary hydraulic pump adapted to feed an auxiliary hydraulic circuit

in which the electric motor is coupled to the hydraulic pump via a first output shaft and presents a second output shaft coupled to the auxiliary hydraulic pump via a clutch,
the controller being adapted to control the clutch, the displacement of the hydraulic pump and the rotational speed of the electric motor as a function of a setpoint value relative to the hydraulic pump and to the auxiliary hydraulic pump.

The auxiliary hydraulic pump is typically a hydraulic pump fixed displacement.

According to an example, the controller is adapted to control the clutch and the electric motor so that shifting from a disengaged configuration to an engaged position of the clutch is completed only when the rotational speed of the electric motor is less than or equal to the lower threshold value.

The present summary also relates to a vehicle comprising such a system.

According to an example, the vehicle comprises a primary axle driven by a primary motor, and a secondary axle adapted to be selectively driven by said propulsion system.

The invention also relates to a control process of a propulsion system for a vehicle propulsion component, said propulsion system comprising
a variable displacement hydraulic pump
a hydraulic motor, adapted to drive the rotation of said propulsion component, the hydraulic motor being driven by the hydraulic pump via a closed-loop hydraulic circuit,
an electric motor, adapted to drive the hydraulic pump,
a source of electric power, adapted to feed the electric motor,
   said process being characterised in that as a function of a setpoint value, the displacement of the hydraulic pump and the rotational speed of the electric motor are controlled so as to achieve the setpoint value while maintaining a rotational speed of the electric motor greater than a lower threshold value, the rotational speed of the electric motor being controlled between the lower threshold value Vmin and a maximal rotational speed Vmax, and the displacement of the hydraulic pump being controlled in a range of displacement values between a lower threshold value C1 and a maximum displacement value Cmax.

According to an example, the displacement of the hydraulic pump and the rotational speed of the electric motor are controlled so as to achieve the setpoint value by maximising the total output of the hydraulic pump and of the electric motor while maintaining a rotational speed of the electric motor greater than the lower threshold value.

According to an example, the displacement of the hydraulic pump and the rotational speed of the electric motor are controlled so as to achieve the setpoint value and to maximise the torque delivered by the electric motor while maintaining a rotational speed of the electric motor greater than the lower threshold value and a displacement of the hydraulic pump greater than a lower threshold value.

According to an example, a temperature value is measured, and the lower threshold value is determined as a function of said temperature value measured in this way.

According to an example, the rotational speed of the propulsion component is determined,
if the rotational speed of the propulsion component is between 0 and a first threshold, the displacement of the hydraulic pump is controlled so as to achieve the setpoint value while maintaining a rotational speed of the electric motor greater than the lower threshold value.

According to an example,
if the rotational speed of the propulsion component is greater than the first threshold and less than a second threshold, the rotational speed of the electric motor is controlled to achieve the setpoint value while keeping the displacement of the hydraulic pump equal to a first displacement value.

According to an example,
if the rotational speed of the propulsion component is greater than the first threshold and less than a second threshold, the rotational speed of the electric motor is controlled to achieve the setpoint value while keeping the displacement of the hydraulic pump equal to a first displacement value,
if the rotational speed of the propulsion component is greater than the second threshold, the displacement of the hydraulic pump and the rotational speed of the electric motor is controlled to achieve the setpoint value by maximising the rotational speed of the electric motor.

According to an example, the control of the hydraulic pump and of the electric motor is carried out by means of predetermined operating point tables of the hydraulic pump and of the electric motor stored in a memory unit, so as to maximise the total output of the hydraulic pump and of the electric motor.

By allowing optimised use of the torque electric motor-variable displacement pump, the invention such as proposed avoids those areas and enables better poor operation which can damage the components, and allows better overall output of the transmission chain, therefore economy of on-board electric power, and better autonomy of the machine. It also minimises the size of the electric motor required based on the required torque.

The invention applies to any machine or engine having a traction chain or an electric drive, in particular agricultural machines, for example tractors and self-propelling sprayers, and construction machinery, e.g. compactors, forklifts, cherry pickers, mechanical shovels, loaders, dozers (or bulldozers as they are commonly known), vehicles, in particular trucks, lorries and powered trailers.

### BRIEF DESCRIPTION OF DRAWINGS

The invention and its advantages will be better understood from reading the detailed description given hereinbelow of different embodiments of the invention given by way of non-limiting examples.

FIG. 1 schematically illustrates a vehicle or engine fitted with a hydroelectric axle drive system.

FIG. 2 is a graphic which schematically illustrates the control according to an aspect of the invention.

FIG. 3 outlines the steps of a control process according to an aspect of the invention.

FIG. 4 presents an example of a system according to an aspect of the invention.

FIG. 5 presents another example of a system according to an aspect of the invention.

In all figures, common elements are designated by identical reference numerals.

### DESCRIPTION OF EMBODIMENTS

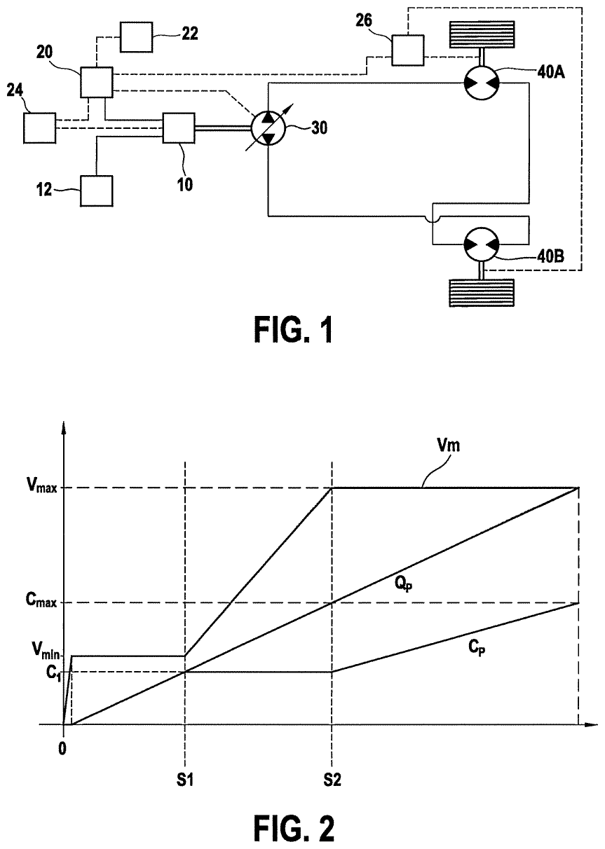

FIG. 1 schematically illustrates a vehicle or engine fitted with a hydroelectric axle drive system.

This figure illustrates an electric motor 10 driven by a battery 12 and controlled by a controller 20. The electric motor 10 is controlled in speed. The electric motor 10 is for example of synchronous type, for example with permanent magnets, or IPM. The electric motor 10 can also be an asynchronous motor with speed control. The electric motor 10 can for example comprise an internal control card and a chopper or converter not shown in the figure. From a setpoint value received from the outside, the current is cut by the chopper in intensity and in frequency to drive the electric motor 10 at the required torque and speed. The electric motor 10 is coupled to a hydraulic pump 30. The hydraulic pump 30 is typically controlled in displacement. The hydraulic pump 30 is connected to a hydraulic circuit shown in simplified form, via which it drives one or more hydraulic motors adapted to drive a vehicle propulsion component in rotation. This hydraulic circuit is designated as being a hydraulic drive circuit or a hydraulic assistance circuit. Propulsion component means for example an axle or a wheel. In the example illustrated, the hydraulic pump 30 supplies two hydraulic motors 40A and 40B mounted in parallel, each of the hydraulic motors 40A and 40B driving a wheel of a vehicle in rotation. It is understood that this embodiment is not limiting, and that any type of hydraulic circuit can be connected to the hydraulic pump 30, comprising one or more hydraulic motors, driving a vehicle propulsion component in rotation, especially an axle or a wheel.

The hydraulic pump 30 is a variable displacement hydraulic pump, typically a hydraulic pump with axial pistons and with inclined plate, the control of the inclination of the plate executing control of the displacement of the hydraulic pump 30, the inclination of the plate being controlled by the controller 20.

The hydraulic motor or hydraulic motors fed by the hydraulic pump 30 are typically fixed displacement hydraulic motors, for example hydraulic radial-piston engines and multilobe cams.

The system such as proposed can be employed for example to carry out the principal transmission of a vehicle, or also define hydraulic assistance on a secondary axle, as opposed to a primary axle driven by a primary motor of the vehicle. In the case of execution of hydraulic assistance, the system can be engaged permanently, periodically, or in predetermined conditions, for example when the speed of the vehicle is less than or equal to a predetermined speed. The operation described below remains unchanged irrespective of the intended application.

The actuation of the propulsion system such as outlined raises problems of controlling the electric motor 10.

The controller 20 such as proposed is configured to execute control of the electric motor 20 and of the hydraulic pump 30 to create operation ensuring safety of the components and optimising output.

For a configuration of the given drive component, for example for a defined wheel diameter, a pump displacement law, a motor displacement, and a defined number of connected motors, a drive speed or a rotational speed of the drive component corresponds to a torque comprising a speed of the electric motor 10 and displacement of the hydraulic pump 30. The controller 20 gives setpoint values to the torque comprising the electric motor 10 and the hydraulic pump 20 to create the preferred drive speed and torque. The electric motor 10 and the hydraulic pump 30 can incorporate closed-loop regulation of their control (that is, incorporating a retroaction loop), or else provide retroaction information to the controller 20. In all cases, the controller 20 can determine the flow rate generated since it has information on the rotational speed of the electric motor 10 and the displacement of the hydraulic pump 30, which corresponds to a drive speed of the drive component.

The controller 20 is typically connected to control members, and is therefore adapted to receive a setpoint value, typically resulting from an action by the user, and which will for example control start-up of the hydraulic assistance.

The setpoint value is typically a flow setpoint value which defines a flow target value to be delivered by the hydraulic pump 30, or a rotational speed setpoint value defining a rotational target value for the propulsion component driven by the system, for example a speed setpoint value of the machine, or a rotational setpoint value for wheels or an axle, or a rotational speed of a motor driving a propulsion component such as a wheel. It is understood that such setpoint values are equivalent.

The controller 20 such as proposed controls displacement of the hydraulic pump 30 and the rotational speed of the electric motor 10 so as to achieve the setpoint value and ensure a minimal rotational speed of the electric motor 10. For example, if the speed drops in load relative to the setpoint value, the controller 20 can boost the torque to keep the setpoint value speed or inversely. In general, the electric motor 10 is controlled to gain control of the speed of the driving of the hydraulic pump directly or indirectly 30.

In fact, an electric motor tends to rise in temperature when operating at a low rotational speed and provides high torque, which causes the risk of degradation. The output of the electric motor 10 is also degraded if it is asked to provide too much torque for a given speed.

The controller 20 such as proposed aims to ensure operation of the electric motor 10 at a rotational speed greater than or equal to a lower speed threshold value, effectively preventing the risk of overheating and therefore degradation of the electric motor 10.

The lower speed threshold value is determined by the computer as a function of data typically stored in a memory unit 22.

The lower speed threshold value can be a fixed value, for example between 800 and 1500 rpm, or between 900 and 1200 rpm, or for example equal to 1000 rpm, or maybe a variable value as a function of temperature.

The system can accordingly comprise a temperature sensor 24, adapted to measure a temperature characteristic of the operation of the electric motor 10. The temperature sensor 24 can be positioned for example near the electric motor 10 or against the electric motor 10 to measure its temperature, or it can measure the ambient temperature.

The controller 20 can then determine the lower speed threshold value as a function of the temperature measured in this way. The lower threshold value Vmin is typically variable as a function of the temperature measured. As a variant, the controller 20 can receive, determine or estimate the temperature by any other adapted means. The lower threshold value Vmin is typically determined to ensure the thermal stability of the system, and especially of the electric motor 10, such that the electric motor 10 rotates at a sufficiently high speed to ensure the discharge of heat, and avoid overheating of the electric motor 10.

In this way, the controller 20 is configured so as to prioritise the rotational speed of the electric motor 10 so that it is greater than or equal to the lower speed threshold value, in this way protecting the electric motor 10 from any overheating. The controller 20 adapts displacement of the hydraulic pump 30 to produce the setpoint value.

The controller 20 is typically configured so as to subsequently maximise the output of the hydraulic pump.

The controller 20 is therefore typically configured to control the displacement of the hydraulic pump and the rotational speed of the electric motor to achieve the setpoint value by maximising the total output of the hydraulic pump and of the electric motor while maintaining a rotational speed of the electric motor greater than a lower threshold value.

The memory unit 22 is typically previously loaded with data of operating characteristics of the hydraulic pump 30 and of the electric motor 10, typically output characteristics or characteristics indicating correspondences between an input value or setpoint value and output parameters of the element in question, for example in the form of charts or tables, and will determine the displacement of the hydraulic pump and the rotational speed of the electric motor 10 so as to maximise the total output as a function of the setpoint value and of the rotational speed of the electric motor 10, which is greater than or equal to the lower threshold value. The data are for example a mapping of loss/output or operation/torque of the hydraulic pump 30 and of the electric motor 10, or of the displacement of the hydraulic pump as a function of the need in flow rate and of pressure delivered, and then define a plurality of operating points for the torque formed by the hydraulic pump 30 and the electric motor 10.

To attain the optimised point of operation, as a function of the data now loaded the torque and the power are determined as a function of the rotational speed, so as to position the operating point of the hydraulic motor 10 at the point supplying the maximal available power.

The controller 20 is typically configured so as to present variable operation according to the drive speed of the axle or of the component driven by the electro-hydraulic traction system, that is, a non-linear operation.

The controller can be configured to define several threshold values corresponding to several operating steps of the system.

The threshold values can for example correspond to a rotational speed of the component driven in rotation by the hydraulic system, for example a rotational speed of an axle.

The illustrated example shows a speed sensor 26, adapted to measure and provide information relative to the rotational speed of the wheels driven by the hydraulic motors 40A and 40B. It is understood that this example is not limiting, and that other sensors or components can be used to define the threshold values. The rotational speed can especially be determined by any adapted means without necessarily using a speed sensor. Reference could be made generally to means for determining the rotational speed of the displacement components, in this case wheels driven by the hydraulic motors 40A and 40B

The threshold values correspond typically to progressive start-up, for which different operating methods can be defined.

By way of example, a first operating method can be defined for values between 0 rpm and S1 rpm, where S1 is a first threshold value.

This first operating method translates the start-up of the vehicle and its being set in motion.

For such a method, it is understood that the need for torque is considerable, and also that the speed to be reached, therefore the flow rate to be provided, is very low. Yet, for the electric motor 10, supplying substantial torque with reduced rotational speed would cause a significant risk of overheating. In this way, for this first operating method, the controller 20 will take control to ensure as a priority that the rotational speed of the electric motor 10 is greater than or equal to the lower threshold value, or typically by retaining a rotational speed of the electric motor 10 which is constant and equal to the lower threshold value. The displacement of the hydraulic pump 30 is then determined so as to achieve the setpoint value.

Once the first threshold S1 is reached, the rotational speed of the electric motor is controlled between the lower threshold value Vmin and a maximal rotational speed Vmax, and displacement of the hydraulic pump 30 is controlled in a range of displacement values between the lower threshold value C1 and a maximum displacement value Cmax so as to achieve the setpoint value. The values Vmin and Vmax are such that Vmax is strictly greater than Vmin. The values C1 and Cmax are such that Cmax is strictly greater than C1.

Once the first threshold S1 is reached, the controller 20 can present a second operating method, in which it typically creates control by retaining displacement of the hydraulic pump 30 equal to a constant value, and it increases the rotational speed of the electric motor 10 to create the setpoint value.

This second operating method can be carried out for example until the electric motor 10 attains its maximal rotational speed, for a second threshold S2.

Once the second threshold S2 is reached, the rotational speed of the electric motor 10 is kept constant and equal to its maximal value, and the controller 20 then controls displacement of the hydraulic pump 30 so as to achieve the setpoint value.

It is evident that below the threshold S1 only a single part of the available torque of the electric motor 10 can be exploited. Between the thresholds S1 and S2 the available power increases and is variable up to full power of the electric motor 10. Beyond the threshold S2, the electric motor 10 can give its full power. In fact, it is the rotational speed of the electric motor 10 which will determine the torque generated. In such an embodiment, the electric motor 10 supplies maximum torque from the second threshold S2.

FIG. 2 is a graph which schematically represents these different operating methods.

The abscissa axis here is the evolution of a value of setpoint value, which can correspond to the rotational speed of an axle, for example.

The axis of the ordinates represents the evolution of the rotational speed of the electric motor 10, the flow rate of the hydraulic pump 30 and the displacement of the hydraulic pump 30.

The different curves illustrate the evolution of these different parameters as a function of the setpoint value:
Vm represents the rotational speed of the electric motor 10,
Cp represents the displacement of the hydraulic pump 30, and
Qp represents the flow rate delivered by the hydraulic pump 30.

As seen in this figure, when the system is being put into operation, that is, when the setpoint value becomes greater than 0, the rotational speed Vm of the electric motor 10 rises rapidly to reach the lower threshold value Vmin. The rotational speed Vm of the electric motor 10 remains constant and equal to Vmin up to a threshold S1. In this first interval, it is the displacement of the hydraulic pump 30 which is modified so as to produce the preferred flow rate Qp. In the example illustrated, the lower threshold value Vmin is represented as being constant. But, as pointed out earlier, the lower threshold value can evolve as a function of temperature. It is therefore understood here that this example is not limiting. According to an example, inasmuch as the rotational speed Vm of the electric motor 10 is less than Vmin, displacement Cp of the hydraulic pump 30 remains zero.

When the setpoint value is between S1 and S2, the displacement Cp of the hydraulic pump 30 is kept constant, equal to a value C1. It is the rotational speed Vm of the electric motor 10 which is modified to produce the preferred flow rate Qp. This value C1 corresponds typically to a lower threshold value of displacement of the hydraulic pump 30, which can for example be a minimal displacement value of the hydraulic pump 30 to ensure operation in nominal conditions.

The value S2 typically corresponds to the setpoint value for which the electric motor 10 reaches its maximal rotational speed Vmax. In this way, when the setpoint value is greater than S2, the rotational speed Vm of the electric motor 10 stays constant and equal to Vmax, and it is the displacement of the hydraulic pump 30 which is modified to produce the preferred flow rate Qp. Cmax indicates the maximal value of the displacement of the hydraulic pump 30.

As a variant or in addition, the controller 20 can be configured, when the setpoint value is between S1 and S2, to maximise the output of the hydraulic pump 30 and of the electric motor 10, by retaining a rotational speed Vm of the electric motor 10 greater than or equal to the lower threshold value Vmin. The controller 20 can for example adjust the rotational speed Vm of the electric motor 10 and the displacement Cp of the hydraulic pump 30 to optimise output, irrespective of the setpoint value applied or over one or more given ranges of setpoint values, but retaining a rotational speed Vm of the electric motor 10 greater than or equal to the lower threshold value Vmin.

As a variant or in addition, the controller 20 can be configured to maximise the torque delivered by the electric motor 10, while maintaining a rotational speed Vm of the electric motor 10 greater than or equal to the lower threshold value Vmin. The controller 20 can for example adjust the rotational speed Vm of the electric motor 10 and the displacement Cp of the hydraulic pump 30 to maximise the torque delivered by the electric motor 10 irrespective of the setpoint value applied or over one or more given ranges of setpoint values, but retaining a rotational speed Vm of the electric motor 10 greater than or equal to the lower threshold value Vmin.

The controller 20 can be configured so as to alternate between different control methods as a function of the conditions of use, and therefore prioritise a given parameter.

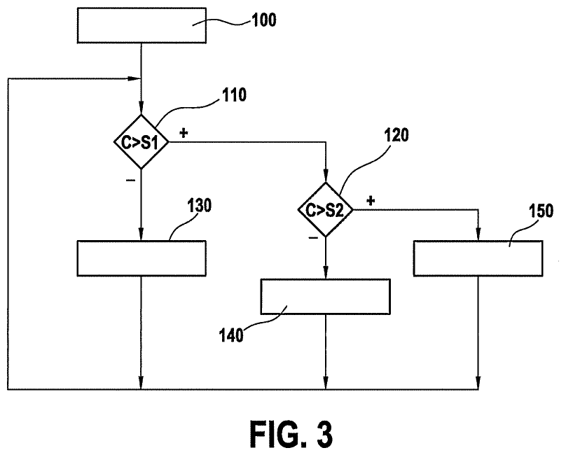

The present invention also relates to a control process of a propulsion system for a vehicle axle. An embodiment of such a control process is described hereinbelow in reference to FIG. 3.

The propulsion system such as considered comprises a variable displacement hydraulic pump, one or more hydraulic motors fed by the hydraulic pump via a closed-loop hydraulic circuit and adapted to drive one or more axles in rotation. The hydraulic motors are typically fixed displacement hydraulic motors. The propulsion system also comprises an electric motor adapted to drive the hydraulic pump, a source of electric power adapted to feed the electric motor, as well as a control component such as a controller which can be connected to sensors and/or memory units or information storage units.

FIG. 3 schematically illustrates a process which comprises a first step 100 of application of a setpoint value, which results typically from an action by the user, and which will accordingly control the commissioning of the hydraulic assistance, for example.

The setpoint value is typically a drive speed setpoint which translates by a flow setpoint value delivered by the hydraulic pump 30, or a setpoint value of rotational speed for the component driven by the system.

The operating method is then determined. In FIG. 3 this means two steps of comparison 110 and 120, in which it is determined successively if the setpoint value is greater than or not to a first threshold S1, and if it is greater than or not to a second threshold S2.

As a function of the achieved determination, the adapted control method will then be applied as already described especially in reference to FIGS. 1 and 2.

In this way, in the example illustrated step 130 corresponds typically to the control method in which the setpoint value is between 0 and S1, and in which it is ensured as a priority that the rotational speed Vm of the electric motor 10 is greater than or equal to the lower threshold value Vmin, or typically retaining a rotational speed Vm of the electric motor 10 constant and equal to the lower threshold value Vmin. The displacement Cp of the hydraulic pump 30 is then determined so as to achieve the setpoint value.

Step 140 corresponds typically to the control method in which the setpoint value is between S1 and S2, and in which the displacement Cp of the hydraulic pump 30 is kept constant, equal to a value C1. It is the rotational speed Vm of the electric motor 10 which is modified so as to attain the preferred flow rate Qp.

Step 140 corresponds typically to the control method in which the setpoint value is greater than S2, and in which the rotational speed Vm of the electric motor 10 remains constant and equal to Vmax, and it is the displacement of the hydraulic pump 30 which is modified so as to attain the preferred flow rate Qp.

The process then adapts the control method as a function of the evolution of the setpoint value, via a loop on the comparison steps 110.

As pointed out previously, the control can be carried out so as to maximise the total output of the hydraulic pump 30 and of the electric motor 10, retaining a rotational speed Vm of the electric motor 10 greater than or equal to the lower threshold value Vmin. The rotational speed Vm of the electric motor 10 and the displacement Cp of the hydraulic pump 30 can for example be adjusted so as to optimise the total output irrespective of the applied setpoint value or over one or more given ranges of setpoint values, but retaining a rotational speed Vm of the electric motor 10 greater than or equal to the lower threshold value Vmin. For example, in reference to the stored characteristics of the pump and electric motor components, for a preferred flow setpoint value the process determines the torque speed of the electric motor-the most advantageous displacement of the pump for proper output, in a field of use where the rotational speed Vm of the electric motor 10 is always greater than the lower threshold value Vmin. The process can take into account the load of the electric motor. For example if the torque required of the electric motor is excessive, the process selects a higher rotational speed Vm of the motor and lower displacement Cp of the hydraulic pump 30 to attain more advantageous overall output.

By way of variant or in addition, the control can be managed so as to maximise the torque delivered by the electric motor 10, while maintaining a rotational speed Vm of the electric motor 10 greater than or equal to the lower threshold value Vmin. For example the rotational speed Vm of the electric motor 10 and the displacement Cp of the hydraulic pump 30 can be adjusted to maximise the torque delivered by the electric motor 10, irrespective of the setpoint value applied or over one or more given ranges of setpoint values, but retaining a rotational speed Vm of the electric motor 10 greater than or equal to the lower threshold value Vmin.

The system such as proposed and the associated control process therefore carry out non-linear control of the rotational speed of the electric motor and of the displacement of the hydraulic pump on the range of operation. The control is carried out by varying the speed of the electric motor 10 and the displacement of the hydraulic pump 30, in the range from Vmin to Vmax and from C1 to Cmax, ensuring minimal rotational speed of the electric motor.

The system such as proposed can also make use of different other speed torques of electric motor 10 and displacement of hydraulic pump 30, in the range from Vmin to Vmax and from C1 to Cmax, for example to avoid a noise mode, or to utilise the components with emphasis on the economy or power. These control laws can be non-linear as a function of the speed of the wheels.

The invention such as proposed defines a control for optimising operation of the electric motor and of the hydraulic pump while protecting the electric motor from any overheating.

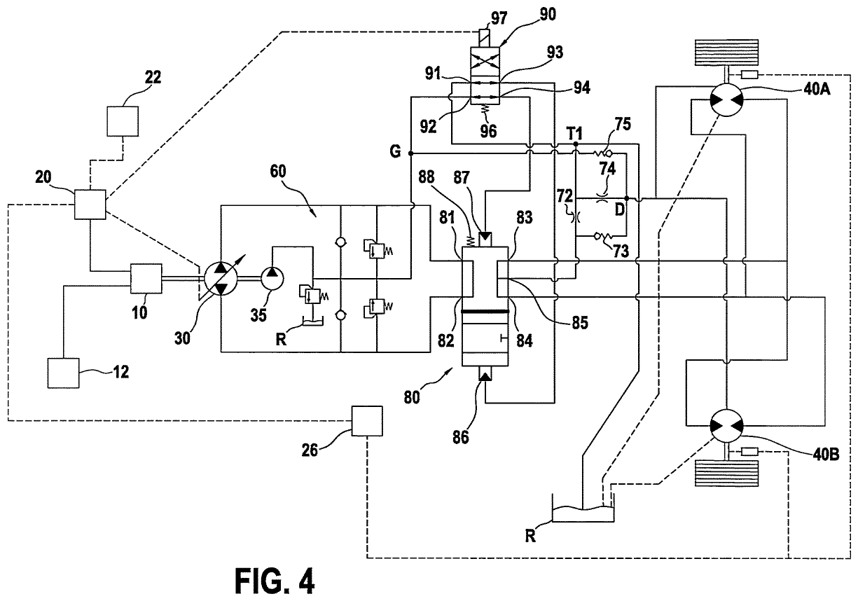

FIG. 4 presents a particular exemplary embodiment of an electrohydraulic transmission system which can be a principal or assistance transmission of a vehicle or an engine, especially assistance which can be selectively engaged or disengaged.

For those assistances which can be selectively engaged, the hydraulic motors 40 are typically of a type which can disengage from wheels, in particular of the radial multilobe cam type which can disengage by retractation of pistons in the block, when there is no more pressure on the engine intake and discharge ports. Such motors can comprise springs for keeping the pistons in a retracted position.

A crankcase pressure can help to return to or keep the pistons in a retracted position. Retractation of the pistons releases the pistons from the cam, which deactivates the motor and allows it to rotate without torque, which releases the driven shaft. When pressure is built up on the engine intake and discharge ports, the pistons exit from their housing and engage on the multilobe cam, connecting the motor to the driven axle. In disengaged position these motors produce no sensitive drag torque. These motors can be engaged at low pressure, which engages the pistons on the cam, and if they are in equipressure at their intake and discharge ports can turn without sensitive torque while being engaged, creating an operating method when freewheeling, but with a certain drag torque.

This figure shows the elements already described previously in reference to FIG. 1, as well as additional elements described hereinbelow.

The hydraulic circuit connecting the hydraulic pump 30 to the hydraulic motors 40A and 40B here comprises a feed circuit 60, driven by a feed pump 35 which is coupled here in rotation to the hydraulic pump 30. It is understood that the feed pump 35 can also be driven in rotation independently of the hydraulic pump 30. The feed circuit 60 also attains a control pressure for hydraulic controls.

The feed circuit 60 has a known structure and performs feeding of the hydraulic circuit, or pours out excess fluid into a tank R.

The hydraulic circuit has a control valve 80, interposed between the hydraulic pump 30 and the hydraulic motors 40A and 40B. As previously, it is understood that this embodiment is not limiting, and can be transposed for one or more hydraulic motors mounted in series or in parallel, for example.

The engagement valve 80 is a valve of type 5/2, which has 5 ports and two positions.

The engagement valve 80 has:
a first port 81 connected to a first port of the hydraulic pump 30,
a second port 82 connected to a second port of the hydraulic pump 30,
a third port 83 connected to a first port of the hydraulic motors 40A and 40B,
a fourth port 84 connected to a second port of the hydraulic motors 40A and 40B, and
a fifth port 85.

The fifth port 85 is connected to a tank R via a restriction 72, to the crankcases of the hydraulic motors 40A and 40B via a calibrated valve 73 and via the restriction 72 and a restriction 74 arranged successively. The crankcases of the hydraulic motors 40A and 40B are connected to the feed circuit 60 via a calibrated valve 75, typically having a calibration of the order of 0.3 bar, allowing circulation of fluid to the feed circuit 60.

In a first configuration, the first port 81 is connected to the second port 82, while the third port 83, the fourth port 84 and the fifth port 85 are connected together. Return means 88 such as a spring keep the engagement valve 80 by default in its first configuration.

In a second configuration, the first port 81 is connected to the third port 83, the second port 82 is connected to the fourth port 84, and the fifth port 85 is blocked.

In this way, in its first configuration the engagement valve 80 on the one hand connects the suction and the discharge of the hydraulic pump 30, and on the other hand it connects the suction and the discharge of the hydraulic motors 40A and 40B. In this way it carries out a bypass function commonly designated by the English term “bypass” of the hydraulic pump 30 and a “bypass” of the hydraulic motors 40A and 40B.

In its second configuration, the engagement valve 80 connects the discharge of the hydraulic pump 30 to the suction of the hydraulic motors 40A and 40B, and the discharge of the hydraulic motors 40A and 40B to the suction of the hydraulic pump 30 for a given direction of rotation. The designations of suction and discharge are reversed in the inverse direction of travel, therefore of flow rate.

Control of the engagement valve 80 is executed by means of two hydraulic controls 86 and 87 in opposition.

The engagement valve 80 is activated by a control valve 90.

The control valve 90 is a valve of type 4/2, which has 4 ports and two configurations.

The control valve 90 comprises:
a first port 91 connected to the fifth port 85 of the engagement valve 80 via the restriction 72,
a second port 92 connected to the feed pump 35 and to the calibrated valve 75,
a third port 93 connected to the hydraulic control 86,
a fourth port 94 connected to the hydraulic control 87.

The control valve 90 has a first configuration in which the first port 91 is connected to the third port 93 and the second port 92 is connected to the fourth port 94, and a second configuration in which the first port 91 is connected to the fourth port 94 and the second port 92 is connected to the third port 93.

The control valve 90 is controlled by an actuator 97, here shown as being an electric actuator, opposed by elastic return means 96, typically a spring.

The control valve 90 is by default in its first configuration, which tends to activate the hydraulic control 87 and position the engagement valve 80 in its first configuration, that is, a configuration in which the hydraulic motors 40A and 40B are not fed by the hydraulic pump 30.

Actuation of the control 97 toggles the engagement valve 80 in its second configuration. This actuates the hydraulic control 86, and positions the engagement valve 80 in its second configuration, and in this way connects the hydraulic motors 40A and 40B to the hydraulic pump 30.

The present invention proposes improved control for engagement or disengagement of the propulsion of the displacement components by the system such as proposed, as presented hereinbelow.

An initial situation in which the entire system is at a standstill is considered. The electric motor 10 is at a standstill, the pressure is zero in the hydraulic circuit, the control valve 90 and the engagement valve are each in their first configuration.

The electric motor 10 is put into service. As already detailed earlier, the commissioning of the electric motor 10 is executed to ensure a higher rotational speed than the lower threshold value Vmin.

The commissioning of the electric motor 10 drives the hydraulic pump 30 in rotation, the displacement of which is zero in the event where it concerns a variable displacement hydraulic pump, and the feed pump 35, to set up the feed pressure in the hydraulic circuit. A time delay is typically implemented so as to allow the feed pressure to be set up in the hydraulic circuit due to commissioning of the feed pump 35.

It is understood that in the event where the feed pump 35 is driven by a separate element, or independently of the hydraulic pump 30, the feed pump 35 is engaged prior to the engagement or displacement of the hydraulic pump 30. For example, the feed pump 35 can be activated by a separate electric motor, which constitutes an independent electro-pump group. In this way, in the event where the feed pump 35 is driven by another element, the latter is typically put into service initially, before the electric motor 10 is commissioned. In this way, commissioning of the electric motor 10 and of the hydraulic pump 30 on the one hand and of the feed pump 35 on the other hand can be simultaneous or sequential, according to the configuration of the system.

Putting the feed pump 35 into service means setting a pressure in the hydraulic loop to the side of the hydraulic pump 30 via feed check valves on the two hydraulic lines, and executing the control pressure, for example for displacement control of the hydraulic pump 30, and for the control of the engagement valve 80 via the control valve 90.

The displacement of the hydraulic pump 30 and/or the rotational speed of the electric motor 10 is then adjusted to supply a flow rate corresponding to a setpoint value applied to the hydraulic motors 40. This setpoint value corresponds typically to the flow rate that would be needed for the system to recopy the speed of the vehicle which is driven by its transmission, and therefore ensures no motor torque on the wheels.

Since the hydraulic pump 30 and the hydraulic motors 40A and 40B are in a bypass situation, the pressure in the circuit is equal to or substantially equal to the feed pressure, or typically between 5 and 20 bar.

The control 97 is actuated to toggle the control valve 90 in its second configuration, which toggles the engagement valve 80 in its second configuration, such that the hydraulic motors 40 are fed by the hydraulic pump 30, in the process commissioning the hydraulic motors 40, and if needed withdrawing the pistons of the hydraulic motor 40 from their housings in the case of a hydraulic motor, the pistons of which can be retracted into their respective housings to achieve a freewheel configuration, as opposed to an engaged configuration in which the pistons are in contact with a multilobe cam or a plate.

The excess in pressure in the crankcase of the hydraulic motors 40A and 40B is purged via the restriction 74 and/or the calibrated valve 75, the latter reinjecting the pressure from the crankcases into the feed circuit 60. Since the hydraulic motors 40A and 40B are engaged, and the flow rate being provided is substantially equal to the displacement speed of the vehicle, the hydraulic circuit is supplying no torque and sensitive traction force. The pressure typically is set up to 80 bar, which defines a situation where the assistance is engaged but in a waiting situation. The setpoint value can be given for a lower pressure, for example 40 bar, in a situation of deceleration or braking of the vehicle. This control can be refined by adjustment using the data from a pressure sensor. Then, when the assistance is used, a setpoint value slightly greater than the speed of advancement of the vehicle, or a pressure control towards higher pressures supplies sensitive traction force, which puts the assistance in effective traction mode. The pressure can rise typically up to 400 bar. As a function of the applied setpoint value, the displacement of the hydraulic pump 30 is then controlled and the rotational speed of the electric motor 10 for example as described previously especially in reference to FIGS. 2 and 3, to adapt to rolling of the vehicle. It is understood that in the event where the feed pump 35 is driven by separate element, or independently of the hydraulic pump 30, the feed pump 35 is then engaged prior to engagement or displacement of the hydraulic pump 30.

In the case of hydraulic assistance on a secondary axle of a vehicle having a primary axle driven in rotation by a principal propulsion system, the setpoint value applied to the system typically aims to synchronise the rotational speed of the secondary axle with that of the primary axle. The rotational speed of the electric motor 10 and the displacement of the hydraulic pump 30 are typically controlled so as to achieve this setpoint value, while a rotational speed of the electric motor 10 greater than the lower threshold value Vmin as described previously is maintained.

A sequence for disengagement of the system will now be described.

An initial situation is considered in which the system is engaged, and the displacement components are driven by the hydraulic motors 40A and 40B, given that the speed can be zero.

Firstly, displacement of the hydraulic pump and/or the rotational speed of the electric motor is controlled so as to lower the pressure in the hydraulic circuit to reach a resting pressure. This resting or waiting position corresponds to a travel mode in which the hydraulic motors are engaged, but are not supplying torque.

The pressure in the circuit is very low, typically 80 bar.

Then, the control 97 of the control valve 90 is disengaged. The control valve 90 is now returned to its first configuration, which will also return the engagement valve 80 to its first configuration.

The engagement valve 80 in its first configuration isolates the hydraulic motors 40 of the hydraulic pump 30. This will cause a drop in pressure in the circuit, the pressure settling at the level of the feed pressure, and if needed this will produce a retractation effect of the pistons in their housings. In fact, when the engagement valve 80 toggles in its first configuration, the hydraulic motors 40 are driven in rotation by the displacement components, typically the wheels or the axles, but are no longer supplied with pressure. This causes a rise in pressure at the discharge of the hydraulic motors 40. The fluid discharged in this way passes through the engagement valve 80, and comes back out via the fifth port 85 before being poured off into the tank R via the restriction 72. Due to the presence of the restriction 72, some of the flow rate will pass through the calibrated valve 73, which typically has a calibration of the order of 0.3 bar. Since the calibrated valve 73 is attached to the crankcases of the hydraulic motors 40, the flow rate which passes through this calibrated valve 73 will cause a rise in pressure in the crankcases of the hydraulic motors 40, and accordingly produce a retractation effect of the pistons of the hydraulic motors 40 in their housings.

The hydraulic motors 40A and 40B are fitted for example with return elements such as springs which tend to position the pistons in their retracted configuration. In this way, in the absence of applied pressure which will cause the pistons to extend from their housings, the latter are retracted and the hydraulic motors have zero displacement.

A time delay can be executed here for example to ensure retraction of the pistons.

Because the hydraulic pump 30 is a variable displacement hydraulic pump, the displacement of the hydraulic pump 30 is controlled so as to bring it to zero displacement. The electric motor 10 is kept at a rotational speed greater than the lower threshold value Vmin.

The electric motor is then stopped, causing stoppage of the hydraulic pump 30, then if needed the feed system is stopped when the feed pump 35 is driven by another motor element.

The system and the process such as shown present an operation which does not require driving a pump when the system is disengaged. It also ensures protection of the different components, and synchronising of the rotational speed in the case of an assistance transmission.

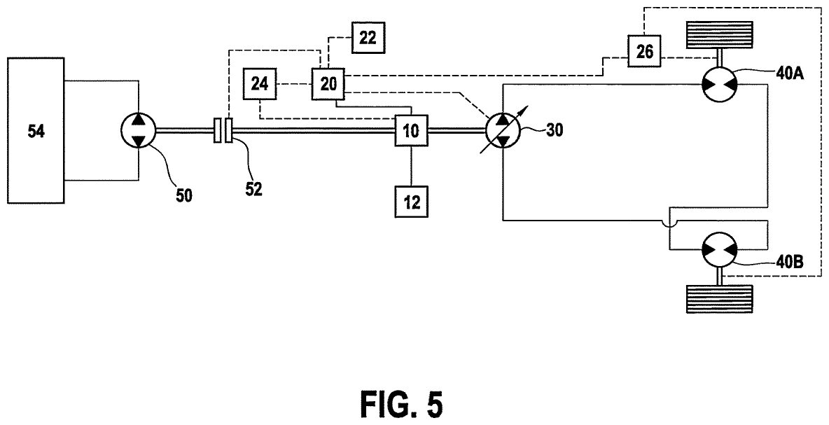

Optionally, the electric motor 10 can have two output shafts; a first output shaft coupled to the variable displacement hydraulic pump 30 as described previously, and also a second output shaft coupled to a fixed displacement auxiliary hydraulic pump 50 via a clutch 52. The auxiliary hydraulic pump 50 typically feeds an auxiliary hydraulic circuit of a vehicle, for example an actuator, a tool, a jack, or more generally any other separate element of the transmission. FIG. 5 presents such an embodiment.

In such an embodiment, the electric motor 10 comprises a variator which is for example installed in a radial extension of the electric motor 10 to enable output of the two output shafts on either side of the electric motor 10. The assembly formed by the electric motor 10 and the variator can form a block.

Similarly, the variable displacement hydraulic pump 30 bearing a valve block can be fixed directly on one side of a shaft on the electric motor 10. The clutch 52 and the auxiliary hydraulic pump 50 can be fixed to the side of the other shaft on the electric motor 10, the whole as formed being very compact.

When the auxiliary circuit 54 is not stressed, the clutch 52 is not engaged, and the auxiliary hydraulic pump 50 is therefore not coupled to the electric motor 10, which especially denies any additional load from being generated on the electric motor 10.

The controller 20 can be configured to control engagement of the clutch 52 and enable start-up of the auxiliary circuit 54 whereof the auxiliary hydraulic pump 50 is driven by the electric motor 10.

According to an embodiment, when the hydraulic transmission is not required and the aim is to put the auxiliary hydraulic circuit into service, the displacement of the hydraulic pump 30 is controlled to be zero. The clutch 52 is engaged so as to couple the auxiliary hydraulic pump 50 to the electric motor 10 and therefore to drive it in rotation so as to deliver a flow rate in the auxiliary hydraulic circuit 54.

The controller 20 is typically configured so that engagement of the clutch 52 is carried out only when the electric motor 10 is at zero speed, or at a speed lower than or equal to the lower threshold value Vmin, which limits wearing of the clutch 52.

The controller 20 then controls the rotational speed of the electric motor 10 so as to achieve a setpoint value applied to the auxiliary hydraulic circuit 54, while maintaining a rotational speed Vm of the electric motor 10 greater than or equal to the lower threshold value Vmin, which ensures proper operation of the electric motor 10 by avoiding or limiting the risk of overheating or degradation.

The auxiliary hydraulic circuit 54 typically comprises pressure discharge means, for example valves, other valves or sprinklers, if necessary for reducing the pressure inside the auxiliary hydraulic circuit 54. In this way, if the flow rate delivered by the secondary hydraulic pump 50 generates excessive pressure when the secondary hydraulic pump 50 is driven at the rotational speed Vmin, the pressure discharge means can execute pressure discharge in the auxiliary hydraulic circuit 54 so as to achieve a setpoint value while maintaining the rotational speed Vm of the electric motor 10 greater than or equal to the lower threshold value Vmin.

The auxiliary circuit is open-loop or closed-loop. It comprises an oil tank, a pump feed and a return. The oil tank can be common to that of the variable displacement hydraulic pump 30. It typically comprises distributors or valves controlled to send oil under pressure to user components, for example jacks to ensure movements, or a fan motor.

As a variant, the controller 20 can be configured so as to allow simultaneous commissioning of the auxiliary hydraulic circuit 54 and of the hydraulic circuit ensuring driving in rotation of one or more displacement components.

In such an operation, the controller 20 therefore controls the rotational speed Vm of the electric motor 20 and the displacement of the hydraulic pump 30 to achieve both a setpoint value relative to the hydraulic propulsion circuit, and a setpoint value relative to the auxiliary hydraulic circuit.

By way of example, given that the setpoint value applied to the auxiliary hydraulic circuit requires a torque Wa, and the setpoint value applied to the hydraulic propulsion circuit requires a torque We, the controller 20 controls the electric motor 10 so that it supplies torque higher than or equal to the sum of Wa+We, which defines the rotational speed Vm of the electric motor 10. Displacement of the hydraulic pump 30 can be adjusted to adjust the rotational speed Vm of the electric motor 10 so that it is between Vmin and Vmax.

Such an embodiment is advantageous in terms of compactness, weight and cost, since it feeds the hydraulic pumps of two circuits with a single electric motor. Also, the electric motor 10 is then typically driven at high speed, which achieves substantial output, and minimises displacement of the hydraulic pumps.

By way of example, the system proposed can for example use a hydraulic pump having a displacement of 20 cc (20 cubic centimetres) which would be driven at a rotational speed of up to 6000 rpm, whereas a conventional system driven by a thermal motor having a maximal rotational speed of 3000 rpm would need a hydraulic pump having a displacement of the order of 50 cc.

Even though the present invention has been described in reference to specific embodiments, it is evident that modifications and changes can be made to these examples without departing from the overall scope of the invention such as defined by the claims. In particular, individual characteristics of the different embodiments as illustrated and/or mentioned can be combined into additional embodiments. Consequently, the description and the drawings must be considered in an illustrative, rather than restrictive, sense.

It is also evident that all the characteristics described in reference to a process are transposable, singly or in combination, to a device, and inversely, all the characteristics described in reference to a device are transposable, singly or in combination, to a process.

1. A propulsion system for vehicle propulsion component,
comprising:
a variable displacement hydraulic pump,
a hydraulic motor, adapted to drive the rotation of said propulsion component, the hydraulic motor being driven by the hydraulic pump via a closed-loop hydraulic circuit,
an electric motor, adapted to drive the hydraulic pump,
a source of electric power, adapted to feed the electric motor, a controller configured so as to, as a function of a setpoint value, control the displacement of the hydraulic pump and the rotational speed of the electric motor so as to achieve the setpoint value while maintaining a rotational speed of the electric motor greater than a lower threshold value, the rotational speed of the electric motor being controlled between the lower threshold value and a maximal rotational speed, and the displacement of the hydraulic pump being controlled in a range of displacement values between a lower threshold value and a maximum displacement value.

2. The system according to claim 1, wherein the controller is configured so as to control the displacement of the hydraulic pump and the rotational speed of the electric motor so as to achieve the setpoint value by maximising the total output of the hydraulic pump and of the electric motor while maintaining a rotational speed of the electric motor greater than the lower threshold value.

3. The system according to claim 1, wherein the controller is configured so as to control the displacement of the hydraulic pump and the rotational speed of the electric motor so as to achieve the setpoint value and to maximise the torque delivered by the electric motor while maintaining a rotational speed of the electric motor greater than the lower threshold value and a displacement of the hydraulic pump greater than a lower threshold value.

4. The system according to claim 1, further comprising a temperature sensor, and in which the lower threshold value is determined by the controller as a function of the temperature value measured by the temperature sensor.

5. The system according to claim 1, in which the hydraulic motor is a fixed displacement hydraulic motor.

6. The system according to claim 1, comprising means for determining the rotational speed of the propulsion component, and in which the controller is configured so as to:
if the rotational speed of the propulsion component is between 0 and a first threshold, control the displacement of the hydraulic pump to achieve the setpoint value while maintaining a rotational speed of the electric motor equal to the lower threshold value.

7. The system according to claim 6, in which the controller is configured so as to,
if the rotational speed of the propulsion component is greater than the first threshold and less than a second threshold, control the rotational speed of the electric motor to achieve the setpoint value while keeping the displacement of the hydraulic pump equal to a first displacement value.

8. The system according to claim 6, in which the controller is configured so as to,
if the rotational speed of the propulsion component is greater than the first threshold and less than a second threshold, control the rotational speed of the electric motor to achieve the setpoint value while keeping the displacement of the hydraulic pump equal to a first displacement value,
if the rotational speed of the propulsion component is greater than the second threshold, control the displacement of the hydraulic pump and the rotational speed of the electric motor to achieve the setpoint value by maximising the rotational speed of the electric motor.

9. The system according to claim 1, also comprising an auxiliary hydraulic pump adapted to feed an auxiliary hydraulic circuit
in which the electric motor is coupled to the hydraulic pump via a first output shaft and presents a second output shaft coupled to the auxiliary hydraulic pump via a clutch,
the controller being adapted to control the clutch, the displacement of the hydraulic pump and the rotational speed of the electric motor as a function of a setpoint value relative to the hydraulic pump and to the auxiliary hydraulic pump.

10. The system according to claim 9, wherein the auxiliary hydraulic pump is a fixed displacement hydraulic pump.

11. The system according to claim 9, in which the controller is adapted to control the clutch and the electric motor so that shifting from a disengaged configuration to an engaged position of the clutch is completed only when the rotational speed of the electric motor is less than or equal to the lower threshold value.

12. A vehicle comprising a system according to claim 1.

13. The vehicle according to claim 12, comprising a primary axle driven by a primary motor, and a secondary axle adapted to be selectively driven by the propulsion system.

14. A control process of a propulsion system for a vehicle propulsion component, said propulsion system comprising:
a variable displacement hydraulic pump
a hydraulic motor, adapted to drive the rotation of said propulsion component, the hydraulic motor being driven by the hydraulic pump via a closed-loop hydraulic circuit,
an electric motor, adapted to drive the hydraulic pump,
a source of electric power, adapted to feed the electric motor,
wherein in that as a function of a setpoint value, the displacement of the hydraulic pump and the rotational speed of the electric motor are controlled so as to achieve the setpoint value while maintaining a rotational speed of the electric motor greater than a lower threshold value, the rotational speed of the electric motor being controlled between the lower threshold value and a maximal rotational speed, and the displacement of the hydraulic pump being controlled in a range of displacement values between a lower threshold value and a maximum displacement value.

15. The process according to claim 14, wherein the displacement of the hydraulic pump and the rotational speed of the electric motor are controlled so as to achieve the setpoint value by maximising the total output of the hydraulic pump and of the electric motor while maintaining a rotational speed of the electric motor greater than the lower threshold value.

16. The process according to claim 14, wherein the displacement of the hydraulic pump and the rotational speed of the electric motor is controlled so as to achieve the setpoint value and to maximise the torque delivered by the electric motor while maintaining a rotational speed of the electric motor greater than the lower threshold value and a displacement of the hydraulic pump greater than a lower threshold value.

17. The process according to claim 14, in which a temperature value is determined, estimated or measured, and the lower threshold value is determined as a function of said temperature value measured in this way.

18. The process according to claim 14, in which the rotational speed of the propulsion component is determined,
if the rotational speed of the propulsion component is between 0 and a first threshold, the displacement of the hydraulic pump is controlled to achieve the setpoint value while maintaining a rotational speed of the electric motor greater than the lower threshold value.

19. The process according to claim 18, wherein if the rotational speed of the propulsion component is greater than the first threshold and less than a second threshold, the rotational speed of the electric motor is controlled so as to achieve the setpoint value while keeping the displacement of the hydraulic pump equal to a first displacement value.

20. The process according to claim 18, wherein
if the rotational speed of the propulsion component is greater than the first threshold and less than a second threshold, the rotational speed of the electric motor is controlled so as to achieve the setpoint value while keeping the displacement of the hydraulic pump equal to a first displacement value,
if the rotational speed of the propulsion component is greater than the second threshold, the displacement of the hydraulic pump and the rotational speed of the electric motor are controlled so as to achieve the setpoint value by maximising the rotational speed of the electric motor.

21. The process according to claim 14, in which the control of the hydraulic pump and of the electric motor is executed by means of tables defining a plurality of predetermined operating points of the hydraulic pump and of the electric motor stored in a memory unit, so as to maximise the total output of the hydraulic pump and of the electric motor.
